(19) United States
(12) Patent Application Publication
(10) Pub. No.: US 2006/0082730 A1
(43) Pub. Date: Apr. 20, 2006

(54) Firearm audiovisual recording system and method

(76) Inventor: Ronald Franks, Kinnelon, NJ (US)

Correspondence Address: Jeffery J. Brosemer, Ph.D., ESQ., 138 S. Telegraph Hill Road, Holmdel, NJ, 07733, US

(21) Appl. No.: 10/967,498

(22) Filed: Oct. 18, 2004

(51) Int. Cl. G03B 21/00; G03B 19/18

(52) U.S. Cl. 352/95

(57) ABSTRACT

A firearm audiovisual recording system including a digital video camera, attachably/detachably connected to a firearm, that is made operational when the firearm is readied for firing, i.e., when it is withdrawn from a holster. The system preferably transmits via wireless mechanisms, the video signals produced by the camera to a local digital video recorder positioned proximate to the camera and located, for example, in the trunk of a police car where it may be stored and simultaneously re-transmitted to another receiver located at a police station. In this manner, not only are the events and circumstances of the firearm usage recorded and memorialized, they are transmitted to other systems/locations for simultaneous observation and/or subsequent review.

### FIELD OF THE INVENTION

This invention relates generally to the field of firearm use and safety. In particular, it relates to an audiovisual system and method that records—in real time—the use of a firearm and attendant circumstances/events surrounding that use.

### BACKGROUND OF THE INVENTION

In-car video recording systems have been documenting police activity for more than a decade. The videotapes they produce have been a staple of “reality shows” that show police in action, often handling traffic violations and drunk driving. Most desirably, the systems have proven to protect the rights of both the police and citizens alike.

Specifically, and as it has turned out, in-car video recording systems not only monitor and document the police activity but also discourage false complaints of police misconduct. With a camera rolling and recording, officers can produce a “very reliable witness” to disputed events.

A widely used, in-car video recording system includes a high-resolution camera installed near the rear-view mirror, optionally next to a small video monitor. System controls and a microphone are often mounted overhead and officers wear wireless microphones. A videocassette recorder is typically locked in a case located in the trunk of the car and provides the recording capability for the scenes observed by the camera and heard by the microphone(s).

The in-car video recording systems are usually activated by an officer, who can leave it running continuously or turn it on via a remote transmitter. Alternatively, the systems may be activated automatically by another action, such as the vehicle's emergency lights being activated.

In operation, the camera captures any activity that is taking place directly in front of the police car. Additionally, such cameras—which typically include a wide angle and zoom capability, may be adjusted manually inside the police car. As a result, a police officer can record—on the spot—the reason(s) for stopping a motorist and the subsequent interactions between motorist and officer.

As one might expect, police departments have realized the enormous value of video recording police activity, as well as any officer-citizen contact, citizen transport in a police car, and probable cause related questions. Typical benefits include increased conviction rates, less time in court proceedings and litigation, increased officer awareness of their conduct, training situations and reinforcement, and overall enhanced understanding of any (recorded) situation or event.

Like most areas of electronic technology, in-car video recording systems have benefited from explosive technological advancements made in recent years, and in particular, the dramatic shift to digital recording. Advantageously, digital in-car video recording systems include many of the same components as its analog predecessor, namely a front-facing camera, and recording device and some sort of activation and control. Further benefits provided by the move to digital in-car recording systems include the compression, real-time transmission and back-end systems and processing used to file, categorize, search, retrieve, archive, and copy back-end systems and processing used to file, categorize, search, retrieve, archive, and copy recorded events.

Because, of its compressibility, and resulting enhanced transmission and storage characteristics, in-car digital video permit background recording, or the ability to take “snapshots” over the entire course of a shift or day, or any time the unit is on, at any predetermined interval, such as 1 frame/minute. Additionally, in-car digital video systems provide for some period of pre-event recording whereby the system is on and continuously recording a moving window of time. When the in-car digital video recording system is eventually activated by, for example, turning on emergency lights, this recorded moving window is added to the beginning of the just-activated recording, thereby recording the events immediately preceding the activation of the in-car digital video system. In such cases, the recorded moving window provides a record of the “probable cause” or other event that prompted the activation of the video record.

Despite these and other distinct advances in the development and application of in-car digital video recording systems, they nevertheless have one particularly significant deficiency. Specifically—and as one can quickly appreciate—they do not record events that occur outside the view of the video camera. This deficiency is particularly frightening when considering events involving firearms that take place and leave no permanent video record.

Accordingly, a video recording system that specifically records events surrounding and during firearm usage would represent a great advance in the documentation of such events.

### DESCRIPTION OF THE PRIOR ART

Prior art attempts to combine firearms with photographic systems have largely focused on systems that make photographs of the firearm's target. U.S. Pat. No. 1,955,300 which issued to Abraham Kurnick on Apr. 17, 1934 for a “Camera Gun”, is exemplary of such prior art attempts.

In particular, disclosed therein is a photographic attachment to a firearm that is operationally connected with the trigger of the firearm such that the discharge of the firearm actuates a camera to take a photograph of the target. When used with a revolver, each successive discharge of the firearm will advance film in the attachment and make successive photographs. Somewhat visionary, the inventor specifically noted in this patent that a primary purpose is to “. . . provide guns, pistols and revolvers with means of obtaining photographic evidence which is not otherwise procurable, as is frequently the case in the course of performance of police duties.”

U.S. Pat. No. 2,144,909 directed to a “Combination Gun and Camera” which issued on Jan. 24, 1939 to Atkin et al. The invention disclosed therein is a firearm, such as a pistol or revolver, having a camera for photographing objects at which the firearm is aimed. Advantageously, the photographic record is a moving (motion) picture, and the motion picture mechanism is operated by the trigger finger of the person using the firearm.

Further improvements to guns outfitted with cameras was disclosed in U.S. Pat. No. 2,282,680 which issued to Fredrick Sonne on May 12, 1942 for a “Gun Camera.” The improvements disclosed included a camera that may be affixed to a gun to photographically record its aim at the moment of discharge, the camera being activated by the recoil of the gun. Of particular interest, the camera disclosed therein is intended to be moved from gun to gun, and the camera shutter is adjustable, such that the camera activation may be made at various stages of recoil.

A “Combined Firearm and Motion Picture Camera” was disclosed in U.S. Pat. No. 3,427,102 which issued to L. H. Wade on Feb. 11, 1969. The firearm disclosed therein was a rifle that carried a movie camera having its focal axis parallel to the barrel. A camera actuating member was located at the rearward end of the rifle stock, permitting a hunter or other shooter to actuate the camera by forcibly urging the rifle stock against his shoulder.

U.S. Pat. No. 4,309,095 which issued to Frederick Buckley on Jan. 5, 1982 for “Camera Mounting Device” discloses a device comprising a set of brackets for supporting a conventional film camera to the telescopic sight of a firearm, and in particular a rifle. Additionally, a cable release is affixed to the trigger of the rifle such that the camera is actuated when the rifle is fired. Advantageously, the invention disclosed therein provides for the detachable securement of a conventional camera to a rifle and the coordination and/or synchronization of camera photography to rifle trigger. As with the prior inventions discussed, this invention permits the photographing of a target at which the rifle is being aimed.

A “Gun Mounted Video Camera” was disclosed in U.S. Pat. No. 4,835,621 that issued to J. W. Black on May 30, 1989. The invention was directed to a video camera recording device attached to a structure resembling a rifle that can be raised to the shoulder and sighted at an object in much the same way that a gun is usually raised to the shoulder and aimed. As a result, a spectator of a competitive event is permitted to monitor “live” the shooting action along the line of sight observed by a participant.

U.S. Pat. No. 6,070,355 which issued on Jun. 6, 2000 to F. Day for a “Video Scope” disclosed a gun-mounted video camera including a gun, a video camera connected to the gun for accepting video images of a target of the gun and a display attached to the gun by a hinge. Quite unlike other gun mounted cameras, the invention disclosed therein permits the viewing and or playback of images as well as their capture.

Similarly, a “Game Hunting Video Camera” was disclosed in a United States Patent that issued to L. A. Holmberg on Apr. 29, 2003 as Pat. No. 6,556,245. According to that invention, a video camera is provided which can be mounted to a firearm or a bow, primarily for recording game hunting. Additionally, the camera has a quick release mount system that allows the video camera to slide onto and off of the weapon. The camera has a liquid crystal display so the hunter may monitor what the camera is recording. A liquid crystal display housing member contains the liquid crystal display and acts as a lens cover when the camera is not recording. Moreover, when the liquid crystal display housing is moved from covering the lens, the camera may start recording automatically. Additionally, the camera is provided with seals, which protect it from the elements that are frequently encountered while hunting.

Finally, a “Photographic Firearm Apparatus and Method” was disclosed in U.S. Pat. No. 6,580,876 which issued to T. Gordon on Jun. 17, 2003. Specifically, a telescopic rifle scope/sight that is fully integrated with a compact digital camera, and which has size, shape and weight characteristics that are substantially the same as those of a conventional, camera-less telescopic scope. To configure a weapon for photography and firing, the scope is placed on the rifle in the same manner as a conventional scope without any additional steps, and the rifle is then fired in a conventional manner.

Alternatively, the invention eliminates the telescopic rifle scope, but maintains the compact digital camera. This embodiment is used with pistols and small-scale firearms that ordinarily do not include a telescopic scope, and in which the shooter views the target directly without the aid of a scope. In the telescopic sight configuration, the compact digital camera is initiated by an infrared detector, which detects body heat from the shooter's face when the firearm is moved into position for firing and the shooter's eye is moved into position for viewing through the scope. Once initiated, the digital camera photographs a series of images spaced apart from one another by fractions of a second and stores these images in an image memory. The shooter then pulls the trigger and fires the firearm in the conventional way. Once the shot is fired, an acoustic, or an acceleration detector detects either the sharp sound of the firing or the recoil due to the firing and send signals the digital camera to permanently record one or more of the images it contains.

In embodiments that eliminate the telescopic scope, initiation preferably takes place by detecting the removal of the firearm (pistol) from its holster or other concealed location, using optical or kinetic detection. By timing the recording of the photograph with reference to the actual crack of the firing, or the actual recoil of the firing, and by having information on the distance of the target and the speed of the ammunition, this invention enables the shooter to fine tune the precise instant at which a photograph is recorded relative to both the firing of the weapon and the bullet striking its target. Consequently, no connection need be established between trigger and camera.

Accordingly, apparatus and/or methods that enhance and/or provide for more comprehensive records of contemporaneous firearm usage and attendant circumstances, would represent a great step forward in the art.

### SUMMARY OF THE INVENTION

Advantageously, we have developed a firearm audiovisual recording system and method that provides a number features and capabilities not present in prior art systems. Specifically, our inventive system includes a digital video camera, attachably/detachably connected to a firearm that is made operational when the firearm is readied for firing, i.e., when it is withdrawn from a holster. The systems transmits the video signals produced by the camera to a local digital video recorder positioned proximate to the camera and located, for example, in the trunk of a police car where it may be stored and simultaneously re-transmitted to another receiver located at a police station. In this manner, not only are the events and circumstances of the firearm usage recorded and memorialized, they are transmitted to other systems/locations for simultaneous observation and/or subsequent review.

Viewed from a first aspect, our invention is directed to a firearm audiovisual system and method that records the audiovisual events and circumstances surrounding firearm usage, and simultaneously transmits the audiovisual signals to a local digital video recorder for storage and/or simultaneous transmission to additional systems/locations, such as monitors located in a police station. As a result, not only are the events and circumstances permanently recorded, they may be observed/reviewed in real time by other persons, and permit appropriate action(s) by those observers.

Viewed from another aspect, our inventive system and method provides an audiovisual record of any target(s), at which a readied firearm is being aimed.

Viewed from yet another aspect, our inventive system and method provides an audiovisual record of a user of a firearm, readying a firearm for firing.

Viewed from still another aspect, our inventive system and method provides an audiovisual record of firearm usage and attendant circumstances surrounding that use, including targets and user(s) of the firearm, to additional, remote observers of that usage, for further review or action.

Viewed from one other aspect, our inventive system and method provides an audiovisual record of attendant circumstances surrounding the deployment of canine police resources and/or more conventional, non-lethal systems and tactics including the use of clubs and shields as well as other, non-lethal systems.

In sharp contrast to prior art systems and methods. Our inventive system and method not only provides a record of the target of a firearm, recorded locally at or within the firearm, our inventive system and method records also the user of the firearm, as well as other attendant circumstances and events, and transmits that record—in real time—to additional locations for further review and action.

As a result of our inventive system and method, the audiovisual record of firearm usage is more complete, permanent and useful than any provided by prior art systems and methods.

Further features and advantages will become apparent with reference to the accompanying drawing and illustrative detailed description.

### BRIEF DESCRIPTION OF THE DRAWING

FIG. 1 is a hypothetical crime scene depicting the operation of the present invention;

FIG. 2(a) is a diagram of a firearm according to a first representative embodiment of the present invention;

FIG. 2(b) is a diagram of a firearm according to an alternative representative embodiment of the present invention; and

FIG. 3 is a block diagram showing representative in-vehicle components of the present invention; and

### DETAILED DESCRIPTION

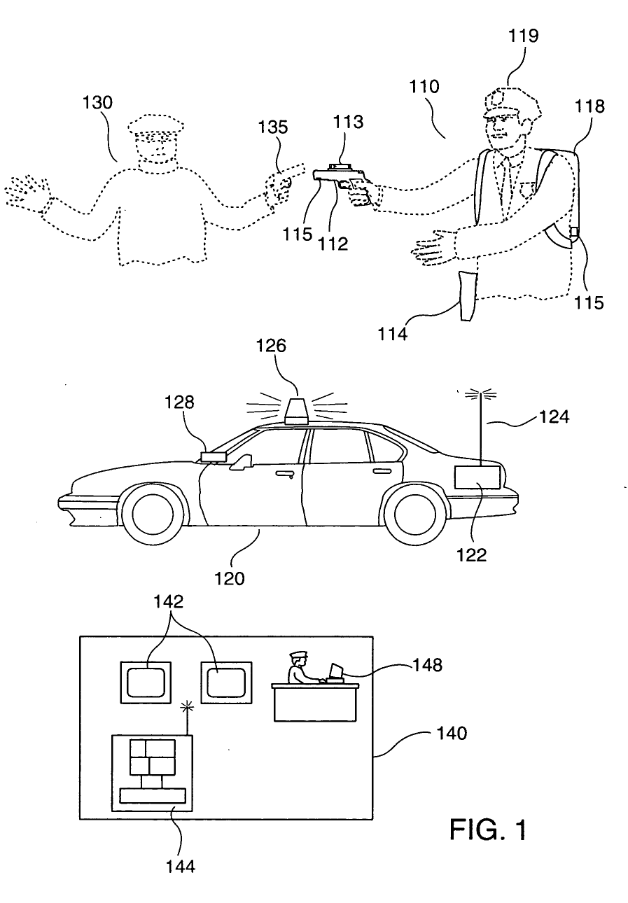

Illustrative examples of our invention will now be presented with reference to the attached drawing. FIG. 1 illustrates a number of principles of our invention. Specifically, and with reference to FIG. 1, there is shown a hypothetical crime scene. In such an environment, a police vehicle 120, happens upon or is directed to the scene, with emergency lights 126 enabled. As with certain prior-art systems, the activation of the emergency lights 126 or other explicit action may activate in-vehicle audiovisual system which includes generally a forward-pointing camera 128, and a digital video recording system 122 that is located in the vehicle 120, typically secured in its trunk.

As can be readily appreciated, when activated, the forward-pointing camera 128 will capture images, which take place substantially directly in front of the vehicle 120 and then conveyed electronically via cable (not shown) to digital video recording system 122. Microphone 119, shown attached to officer 110 and which is typically wireless, provides audio input to the audiovisual images captured by camera 128 and recorded on digital video recorder 122.

Unfortunately, and as noted earlier, when events take place out of the direct view of forward-pointing camera 128, those events will not be recorded (at least visually). Such situations are both common and likely when, for example, a police officer 110 is forced to leave the immediate scene of his/her vehicle 120 for investigative purposes or alternatively, to pursue a fleeing suspect 130.

One can quickly appreciate the significant deficiencies inherent in the prior art when considering this hypothetical if, for example, the situation depicted therein develops into one in which firearms are used. In particular, such firearm usage, when out of the view of forward-pointing camera 128, will not be memorialized in an audiovisual recording.

Our inventive system and method overcomes this particular deficiency while providing a number of other advantages, by providing an audiovisual recording of events and/or circumstances surrounding the use of firearm by policeman 110. With continued reference to FIG. 1. and in particular to policeman 110 and suspect 130, it is noted that both are carrying firearms 112 and 135, respectively. According to our inventive teachings however, the events and circumstances surrounding the use of firearm 112 will be recorded.

In particular, firearm 112, which is normally carried by policeman 110 in holster 118, includes a video camera 113, which may become operational when the firearm 112 is readied for firing by, for example being removed from holster 118. As can be readily appreciated, detecting the removal of the firearm 112 from the holster 114 may be accomplished by a number of methods; such as proximate sensors 115 located on firearm 112, holster 114 or both. In this manner, the sensors may detect when the firearm 112 is removed from holster 114, or when a finger or other object is placed upon firearm trigger (not specifically shown).

When the firearm 112 is removed from the holster 114 or otherwise readied for firing, the video camera 113 is made operational. In one embodiment, the video camera 113 is electrically and video attached to a remote system pack 118 that is carried by the policeman 110. The remote pack 118 includes, for example, power, local storage, local processing and transceiver for transmitting video images captured by camera 113 positioned on firearm 112 to a remote location, i.e., vehicle 120. Alternatively, the firearm 113 may contain power/processing/storage/transceiver carried in system pack 114. Such a “compact” configuration is preferred and desirable with newer, axially stacked firearms, wherein projectiles are axially stacked in a barrel of the firearm.

The remote pack 118 may advantageously provide additional processing that enhances the video record of the firearm usage. In particular, and as noted before, when the firearm 112 is readied for firing, the video camera 113 attached to the firearm becomes operational. Specifically, it records the object(s) that the firearm 112 is being trained upon (such as the suspect 130). Additionally, and as taught by the applicants of the present invention, the video camera 113 may also provide a “split image” signal such that it also record the object(s) using the firearm namely, the policeman 110. In this inventive manner, the recording provides a record of both target and user. Still further, when the video camera 113 is outfitted with panoramic lenses (not specifically shown) the image(s) recorded from such a configuration will include not only the target and the user of the firearm, but the surrounding circumstance(s) as well.

Returning now to the discussion of the remote pack 118, it is noted that as images attendant to the operational firearm 112 are recorded, many of the images may in fact turn out to be not particularly relevant. That is, a great deal of time may elapse between readying the firearm 112 and its subsequent discharge. This leads to a lot of potentially “wasted footage”. Such waste is particularly significant when dealing with a wireless transmission system such as that disclosed here, as the wireless bandwidth is potentially very scarse.

Accordingly, the remote pack 118 optionally provides for the compression of the video record prior to its transmission to a remote location such as the vehicle 120—in order to maximize the utilization of available wireless bandwidth. Of further advantage, the remote pack 118 may dynamically adjust the amount of compression, depending upon whether the video is particularly relevant at a given point in time prior to its transmission.

For example, it should be readily understood that—as noted before—not all of the video recorded by the video camera 113 need be particularly relevant. However, it should be also readily appreciated that a video record made immediately before and after the discharge of firearm 112 is particularly relevant. Additionally, it should also be readily understood that when digital signals such as the video signal resulting from the operation of the video camera 113 is compressed, a certain amount of “loss” in video quality results. Accordingly, what is desired is a system that does not significantly and detrimentally compress (increase loss) during particularly relevant periods of recording and which may significantly and potentially detrimentally compress during irrelevant periods of recording.

Advantageously, our inventive system may provide the selective compression of video signals generated by the video camera 113 prior to transmission to remote locations such as vehicle 120, by detecting the discharge of the firearm by, for example, accelerometers or other known sensors (not specifically shown). During irrelevant periods, the compression may be enhanced. During relevant periods (surrounding discharge) the compression may be decreased such that the overall video quality is increased.

As noted, the video signal that originates in video camera 113, is locally stored, optionally compressed and transmitted to remote site such as vehicle 120 where it is locally stored on digital video recorder 122. Of further advantage, both sets of video signals (from firearm video camera 113) and vehicle forward-pointing camera 128 may be simultaneously recorded by digital video recorder 122, stored, and transmitted further via vehicle transceiver 124, advantageously co-located with the digital video recorder 122 located in the vehicle 120.

Importantly, this subsequent re-transmission of the video signals may take place—in real time—substantially simultaneously with their occurrence and observation. Advantageously, this retransmission to—for example—a remote site such as a police station 140 permits the further recordation and archive on remote recording systems 144 and/or real-time review of events on monitors or other displays 142 by station personnel 148. In this manner, timely decisions may be made, for example, to send backup or other “help” to the field where events are occurring.

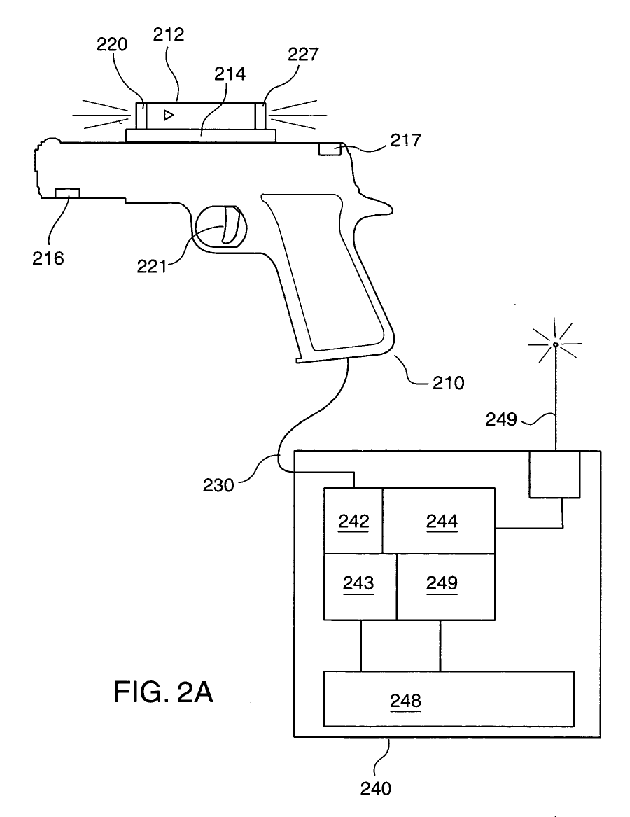

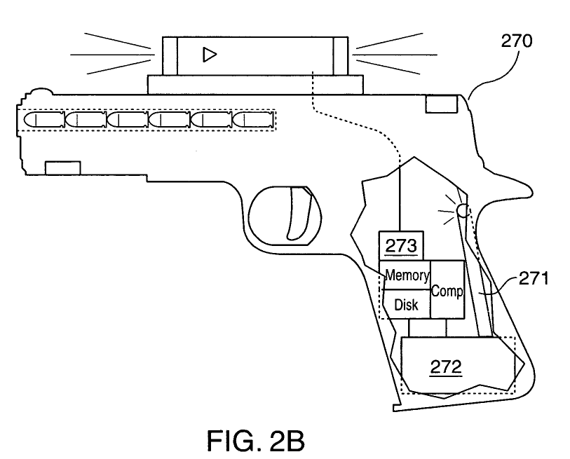

Turning now to FIG. 2(a), there is shown a diagram that more explicitly details many of the components described in the discussion of FIG. 1. In particular firearm 210 includes a video camera 212 that is attachably connected to the firearm by mount 214 that advantageously permits the attachment of the video camera 212 to the firearm 210 without interfering with the normal sighting. The video camera may optionally include a variable lens system 220 directed at a target. The variable lens system may include autofocusing mechanism (not explicitly shown) to achieve proper focus of a target, which may move.

As noted, our invention includes the ability to not only view and record a target, but also may also view and record an: image of a user (not specifically shown) of the firearm 210. Accordingly, the video camera 212 may include a splitter or prism or other mechanism to simultaneously acquire an image of the user of the firearm along with the target. Since the user of a firearm does not necessarily move relative to the firearm itself, a fixed or variable lens 227 may further enhance the user's image to the video camera 212. Still further, and according to the present invention, the video camera 212 may additionally include panoramic lens(es), such that surrounding circumstance is recorded in addition to the user and target of the firearm 210.

Firearm 210, preferably, may further include one or more sensors for determining the status of the firearm 210. In particularly, a proximity sensor 216, for example, may be used to determine when the firearm 210 has been withdrawn from a holster (not shown) or other, concealed location. Alternatively, trigger sensor 221, may be used to determine when a user's finger is positioned to discharge the firearm. The use of these multiple, independent sensors provide for a more accurate determination of the firearm 210 being readied for firing, as, for example, it could be discharged (by pulling the trigger) when it remains in its holster. Consequently, the trigger sensor 221 would detect that preparation despite the firearm 210 being holstered.

Additionally, and as we have noted, it is useful to not only determine when the firearm is readied, but when it is discharged as well. Consequently, sensor such as accelerometer 217 may make such a determination.

Images viewed by the camera 212 are conveyed to local system pack 240 via interface cable 230 which may advantageously provide power and control information to the camera while conveying received video signals. Signals received by the system pack 240 may be locally stored/processed prior to wireless transmission via transceiver/antenna system 249 to remote sites (not shown).

In particular, system pack 240 may include processor 242 for programmably processing the video signal(s) received from the video camera 212, a memory for storing/processing the signals, optional disk 247 for additional storage of received or processed signals, and compressor 244 for optionally, variably compressing the received video signal(s) prior to transmission. As noted, the variable compression capability may be enabled, for example, during periods of particularly relevant video transmission. Lastly, a battery 248 or other power device provides power to the video camera and its support electronics.

Turning now to FIG. 2(b), there is shown an alternative embodiment of our invention. Specifically, we show a firearm 270, with substantially all of the same features/functions of that shown in FIG. 2(a), without the necessity for a system pack.

This “more compact” representation of our invention is realized not only by inevitable improvement(s) in electronics and batteries, but through firearm improvements/alternatives as well. In particular, such embodiments are envisioned for newer firearms, having projectiles axially stacked in the barrel, thereby making the handle and other areas of the firearm—which normally contain ammunition—available for electronics and other items necessary to practice our invention.

Returning now to FIG. 2(b), the firearm 270 depicted therein includes video processing/transmission electronics 273 located in the handle of the firearm 270. Likewise, batteries/power 272 and any necessary antenna/transceiver 271 may be located in the handle of such a firearm 270 as well.

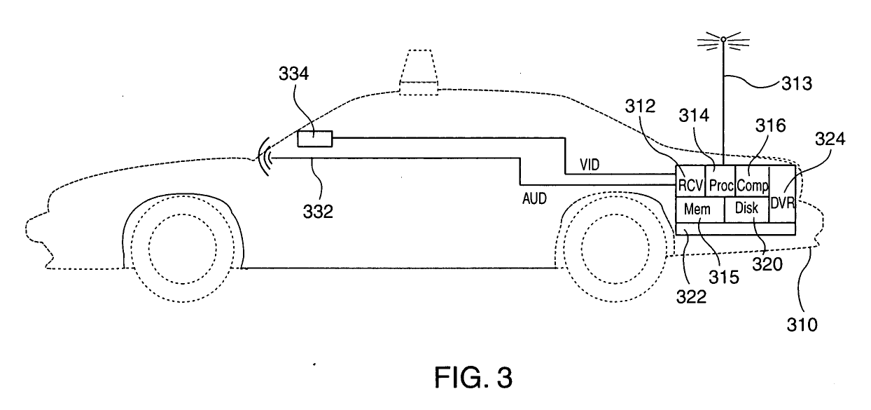

Turning now to FIG. 3. there is shown a block diagram of a representative in-vehicle system according to the present invention. Specifically, in-vehicle system 310 includes a receiver 312, for receiving audiovisual signals from both the firearm video camera (not specifically shown) via antenna 313, and the in-vehicle camera(s) 334 and audio 332.

Similar to the remote systems, the in-vehicle system 310 includes a processor 314 for programmably processing received audiovisual signal(s), and storage /memory systems 315, 320, 322 which may further comprise a digital video recorder system 324.

Prior to further transmission to remote site(s) such as a police station, the audiovisual signals may be further selectively compressed through the action(s) of compressor 316, or the programmable processor 314. In this manner, transmitted audiovisual signals may be processed to take advantage of available wireless bandwidth.

It should be noted that the wireless transmission of the audiovisual signals between for example, a remote firearm and the in-vehicle system, might be quite different from the wireless transmission of the audiovisual signals between in in-vehicle system and the further remote site(s) such as the police station. This is due, in part, to the widely different power/processing capabilities that may be present at each of the respective sites. Regardless of the particular signaling system/format that is used, those skilled in the art will quickly recognize that a variety of formats and/or protocols are available, and are considered as a matter of design choice from the perspective of the present invention.

Of course, it will be understood by those skilled in the art that the foregoing is merely illustrative of the principles of this invention, and that various modifications can be made by those skilled in the art without departing from the scope and spirit of the invention. In particular, and as noted, it is understood that any of a number of wireless signaling formats/protocols may be utilized to effect communication from firearm to in-vehicle system and likewise from in-vehicle system to a further remote site such as a stationhouse. Additionally, it is understood that our invention is not to be viewed as limited to a particular type/size of firearm. Lastly, it is anticipated that our invention will find application in additional police equipment, such as clubs and/or shields. Also, our inventive system may be deployed in conjunction with canine resources, thereby providing live audio/video of the canine environment. In such instances, we anticipate that much value will be realized from the deployment of our invention in non-lethal situations. Accordingly, my invention is to be limited only by the scope of the claims attached hereto.

What is claimed is:

1. A firearm audiovisual recording system comprising:
a firearm including;
a means for acquiring a digital video image of a target at which the firearm is aimed;
a means for processing the acquired digital video image; and
a means for wirelessly transmitting the processed digital video image to an upstream video processing system.

2. The firearm audiovisual recording system of claim 1 further comprising:
a means for acquiring a digital video image of a user of the firearm, simultaneously with the acquisition of the digital video image of the target.

3. The firearm audiovisual recording system of claim 1 further comprising:
a means for determining when the firearm is being readied for firing.

4. The firearm audiovisual recording system of claim 1 further comprising:
a means for determining whether the firearm has been fired.

5. The firearm audiovisual recording system of claim 1 further comprising:
a means for determining when particular portions of acquired digital video images are particularly relevant.

6. The firearm audiovisual recording system of claim 5 further comprising:
a means for selectively compressing the acquired digital video images, prior to their wireless transmission, depending upon whether the digital video images are particularly relevant.

7. The firearm audiovisual recording system of claim 1 further comprising:
an upstream means for receiving and processing the wirelessly transmitted video signal, said means for upstream processing being proximately located to said firearm, and further including a means for storing the received video signal and a means for further wirelessly transmitting the received and processed video signal to a further upstream video processing system.

8. A firearm audiovisual recording system comprising:
a firearm including:
a video camera for acquiring a digital video image of a target at which the firearm is aimed;
a processor, for processing the digital video image acquired by the video camera;
a wireless transmitter for wirelessly transmitting the processed digital video images to an upstream video processing system, said upstream video processing system being proximately located to the firearm; and
a sensor, attached to the firearm for determining when the firearm is readied for firing;
such that the video camera is made operational when, as a result of the sensor output, a determination is made that the firearm is readied for firing.

9. The firearm audiovisual recording system of claim 9 further comprising:
a compressor, for compressing the processed digital video images prior to their wireless transmission.

10. The firearm audiovisual recording system of claim 9 further comprising:
a relevance indicator, for determining when particular portions of acquired digital video images are particularly relevant.

11. The firearm audiovisual recording system of claim 10 wherein said compressor further comprises:
a variable compressor, for variably compressing the processed digital video images prior to their wireless transmission wherein the variable compressor decreases the amount of compression applied to the digital video images when such images are particularly relevant and increases the amount of compression when the digital video images are not particularly relevant.

12. The firearm audiovisual recording system of claim 10 wherein the video camera further acquires a digital video image of a user of the firearm simultaneously with the acquisition of the digital video image of the target of the firearm.

13. The firearm audiovisual recording system of claim 12 wherein the video camera further acquires a digital video image circumstance(s) peripheral to the firearm simultaneously with the acquisition of the digital video image of the user of the firearm and the target of the firearm.

14. A firearm audiovisual recording system comprising:
a firearm including;
a video camera, attached to the firearm, for acquiring digital video images of a target at which the firearm is aimed and generating digital video signals representative of those images; and
one or more sensors, for determining when the firearm is being readied for firing;
a local processing/storage unit, electrically and audiovisually connected to the video camera and the one or more sensors, said local processing/storage unit including:
a processor for programmably processing the digital video signals generated by the video camera;
memory, for temporarily storing the digital video signals and/or the processed digital video signals;
additional memory, longer duration storage of the digital video signals and/or the processed digital video signals;
a variable compressor, for variably compressing the processed digital video signals;
a transceiver/antenna system, for wirelessly transmitting the compressed digital video signals to an upstream video processing/storage system situated proximate to the firearm; and
batteries, in electrical connection with, and providing electrical power to the local processing/storage unit and the digital video camera and the one or more sensors;
an upstream video processing/storage system, situated proximate to the firearm, for receiving/processing/storing the video signals wirelessly transmitted by the local processing/storage unit, said upstream video processing/storage system including:
a wireless transceiver/antenna system, for receiving the video signals wirelessly transmitted by the local processing/storage unit; and
a memory, for storing the received video signals.

15. The firearm audiovisual recording system of claim 14 wherein said upstream video processing/storage system further comprises:
the wireless transceiver/antenna system, for wirelessly transmitting the received video signals further upstream to a video processing/storage/review system,
and said further upstream video processing/storage/review system having:
a wireless antenna/receiver, for receiving the video signals wirelessly transmitted further upstream;
a storage system, for storing the video signals received by the processing/storage/review system; and
a review system, for reviewing the video signals received by the processing/storage/review system.

16. The firearm audiovisual recording system of claim 15 wherein the review system includes a visual display system for displaying in near-real-time the video signals generated by the video camera attached to the firearm.

17. The firearm audiovisual recording system of claim 14 further comprising:
a dual-optical system, for simultaneously generating, by the video camera attached to the firearm, a video image of a user of the firearm simultaneously with the generation of the video image of the target of the firearm.

18. The firearm audiovisual recording system of claim 17 wherein said further upstream processing/storage/review system further comprises:
a split-display, operational with the review system, for simultaneously displaying the video image of the user of the firearm with the video image of the target of the firearm.

19. The firearm audiovisual recording system of claim 15 wherein the upstream video processing/storage system further comprising:
a variable compressor, for variably compressing the video signals that are subsequently transmitted to the further upstream video processing/storage/review system.

20. The firearm audiovisual recording system of claim 14 further comprising:
a relevance indicator, which determines the particular relevance of video signals thereby causing the variable compressor to apply a lower level of compression to transmitted video signals when the video signals are particularly relevant and to apply a greater level of compression to transmitted video signals when the video signals are not particularly relevant.

21. A firearm audiovisual recording method comprising:
determining, whether a firearm is being readied for firing;
acquiring, after the firearm is readied, from a digital camera attached to the firearm, a digital video image of a target at which the firearm is aimed;
processing the acquired digital video images; and
wirelessly transmitting the processed digital video image to an upstream video processing system wherein the upstream video system is situated geographically proximate to the digital camera.

22. The method of claim 21 further comprising:
acquiring, simultaneously with the acquisition of the digital video image of the target, from the digital camera attached to the firearm, a digital video image of a user of the firearm.

23. The method of claim 22 further comprising:
determining, whether the firearm has been fired.

24. The method of claim 23 further comprising:
determining, based upon the firearm firing determination, whether particular portions of the acquired digital video images are particularly relevant.

25. The method of claim 24 further comprising:
selectively compressing, as a function of the particular relevance of the acquired digital video images, the digital video images prior to their wireless transmission.

26. The method of claim 25 further comprising:
receiving, processing, and storing, by the geographically proximate upstream video processing system, the wirelessly transmitted digital video images.

27. The method of claim 26 further comprising:
wirelessly transmitting, by the upstream video processing system to a further upstream video processing/storing/reviewing system, the received, processed and stored, wirelessly transmitted digital video images.
